(19) United States
(12) Patent Application Publication
(10) Pub. No.: US 2023/0075530 A1
(43) Pub. Date: Mar. 9, 2023

(54) Anomaly Detection Using Gaussian Process Variational Autoencoder (GPVAE)

(71) Applicant: Spotify AB, Stockholm (SE)

(72) Inventors: Judith Bütepage, Enskededalen (SE); Lucas Maystre, London (GB)

(73) Assignee: Spotify AB, Stockholm (SE)

(21) Appl. No.: 17/465,417

(22) Filed: Sep. 2, 2021

(51) Int. Cl. G06N 3/08; G06N 3/04

(52) U.S. Cl. CPC G06N 3/08; G06N 3/04

(57) ABSTRACT

A method comprises the following steps: providing a Gaussian process variational autoencoder (GP-VAE) including a Gaussian process (GP) encoder and a neural network decoder; selecting a plurality of inducing points in a data space; generating a mapping of the plurality of inducing points in a latent space; and training the GP-VAE using a training dataset.

### BACKGROUND

Nowadays, machine learning (ML) systems are employed in many areas, ranging from medical care to autonomous cars. Machine learning systems are also used for anomaly detection. Anomaly detection, also referred to as outlier detection, is the identification of rare items, events, or observations which raise suspicions by differing significantly from the majority of the data. Abnormal or atypical behavior representations may be detected using various anomaly detection techniques. Typically the anomalous items will translate to some kind of problem such as bank fraud, a structural defect, medical problems or errors in a text. ML-based anomaly detection is evolving.

In one example, ML-based anomaly detection can be used for detecting an unknown animal in front of an autonomous car. Even if the unknown animal is not within the training dataset, the machine learning systems may still capture the unknown animal and enable the autonomous car to adjust itself accordingly. In another example, ML-based anomaly detection can be used for detecting medical anomalies. In yet another example, ML-based anomaly detection can be used for detecting irregular torque measurements in a robotic arm.

There are different categories of anomaly detection techniques. Unsupervised anomaly detection techniques detect anomalies in an unlabeled testing dataset under the assumption that the majority of the instances in the dataset are normal by looking for instances that seem to fit least to the remainder of the dataset. Supervised anomaly detection techniques require a dataset that has been labeled as “normal” and “abnormal” and involves training a classifier. Semi-supervised anomaly detection techniques construct a model representing normal behavior from a given normal training dataset, and then test the likelihood of a test instance to be generated by the utilized model.

Successful applications of ML in the real world require systems that are highly accurate, robust to adversarial attacks and capable of autonomously detecting anomalous or novel data points. In larger ML systems, the latter is especially important as different components need to be able to communicate uncertainty about their decisions. Examples of such systems include autonomous cars, in which the vision systems need to be able to flag unknown objects or behaviors whereas online platforms need to filter out abnormal user behavior. Thus, automatic methods for anomaly or out-of-distribution (OOD) detection are important for the design of large-scale ML systems.

Ideally, OOD detection mechanisms should be capable of being integrated into any ML systems, which requires it to be versatile and applicable to any type of data. Variational autoencoders (VAEs) generally fulfill these requirements. VAEs are artificial neural network architectures, combining ideas from approximate inference and Bayesian modelling with neural networks. VAEs are a class of generative models that can be applied in supervised and unsupervised settings. VAEs are variational Bayesian methods with a multivariate distribution as prior, and a posterior approximated by an artificial neural network. A VAE typically includes a neural network encoder and a neural network decoder, forming the so-called variational encoder-decoder structure. The neural network encoder is an artificial neural network able to reduce its input information into a bottleneck representation named latent space (also referred to as the “z space”). The neural network decoder is an artificial neural network designed to be the mirror architecture of the neural network encoder. The neural network decoder takes as input the compressed information coming from the latent space, and then expands it to produce an output that is as equal as possible to the input of the neural network encoder. While for an autoencoder, the decoder input is trivially a fixed-length vector of real values, for a VAE, it is necessary to introduce an intermediate step: given the probabilistic nature of the latent space, it is possible to consider it as a multivariate Gaussian vector. With this assumption, and through the technique known as the reparametrization trick, it is possible to sample populations from this latent space and treat them precisely as a fixed-length vector of real values.

From a systemic point of view, the VAE models receive as input a set of high dimensional data and then adaptively compress it into a latent space (referred to as the encoding process) and finally try to reconstruct it as accurately as possible (referred to as the decoding process).

VAEs can be used for continual learning, can model discrete, continuous and temporal data, and can be integrated with deep learning systems end-to-end. If used as an OOD mechanism, VAEs should also have the ability to reliably detect OOD data points. Specifically, VAEs should in theory assign low likelihood values to OOD data and high likelihood values to data points from the training distribution, also referred to as in-distribution (ID). However, this is not always the case. As such, the standard VAE model cannot reliably detect OOD data.

### SUMMARY

In general terms, this disclosure is directed to anomaly detection using machine learning techniques.

One aspect can include a method. The method comprises the following steps: providing a Gaussian process variational autoencoder (GP-VAE) including a Gaussian process (GP) encoder and a neural network decoder; selecting a plurality of inducing points in a data space; generating a mapping of the plurality of inducing points in a latent space; and training the GP-VAE using a training dataset.

Another aspect can include at least one non-transitory computer readable storage device storing data instructions that, when executed by at least one server including at least one processor, cause the at least one server to: provide a GP-VAE including a GP encoder and a neural network decoder; select a plurality of inducing points in a data space; generate a mapping of the plurality of inducing points in a latent space; and train the GP-VAE using a training dataset.

### BRIEF DESCRIPTION OF THE DRAWINGS

FIG. 1 is a diagram illustrating an example of an anomaly detection system.

FIG. 2 is a diagram illustrating an example of the GP-VAE of FIG. 1.

FIG. 3 is a flowchart diagram illustrating an example of a training flow.

FIG. 4 is a diagram illustrating an example of the testing dataset.

FIG. 5 is a flowchart diagram illustrating an example of a latent variable-based OOD detection process.

FIG. 6 is a flowchart diagram illustrating an example of a likelihood-based OOD detection process.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

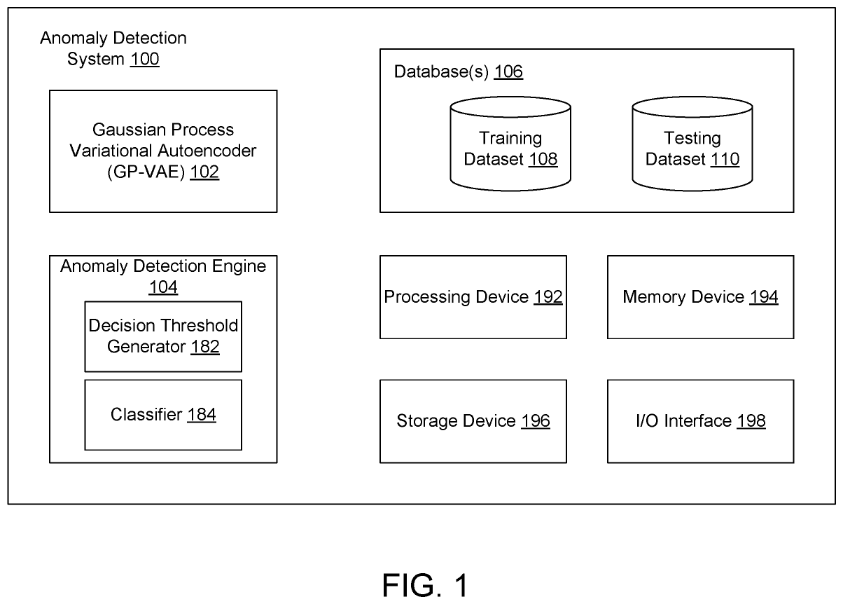

FIG. 1 is a diagram illustrating an example of an anomaly detection system 100. In the example of FIG. 1, the anomaly detection system 100 includes, among other things, a Gaussian Process Variational Autoencoder (GP-VAE) 102, an anomaly detection engine 104, one or more databases 106, a processing device 192, a memory device 194, a storage device 196, and peripheral devices 198. In the example of FIG. 1, the anomaly detection engine 104 further includes, among other things, a decision threshold generator 182 and a classifier 184.

In an example, the processing device 192 includes one or more central processing units (CPU). In other embodiments, the processing device 192 additionally or alternatively includes one or more digital signal processors, field-programmable gate arrays, or other electronic circuits.

The memory device 194 operates to store data and instructions. In some embodiments, the memory device 194 stores instructions and data related to the GP-VAE 102 and the anomaly detection engine 104. The processing device 192 may access the memory device 194 to implement the functions of the GP-VAE 102 and the anomaly detection engine 104, which will be described in detail below.

The storage device 196 operates to store instructions and data used by the anomaly detection system 100. In one embodiment, the storage device 196 operates to load contents of the storage device 196 into the memory device 194. In one example, the storage device 196 may be a nonvolatile storage device for storing data and/or instructions for use by the processing device 192. In another example, the storage device 196 may be implemented, for example, with a magnetic disk drive or an optical disk drive.

The peripheral devices 198 may include any type of computer support device, such as, for example, an input/output (I/O) interface configured to add additional functionality to the anomaly detection system 100. For example, the peripheral devices 198 may include a network interface card for interfacing the anomaly detection system 100 with a network.

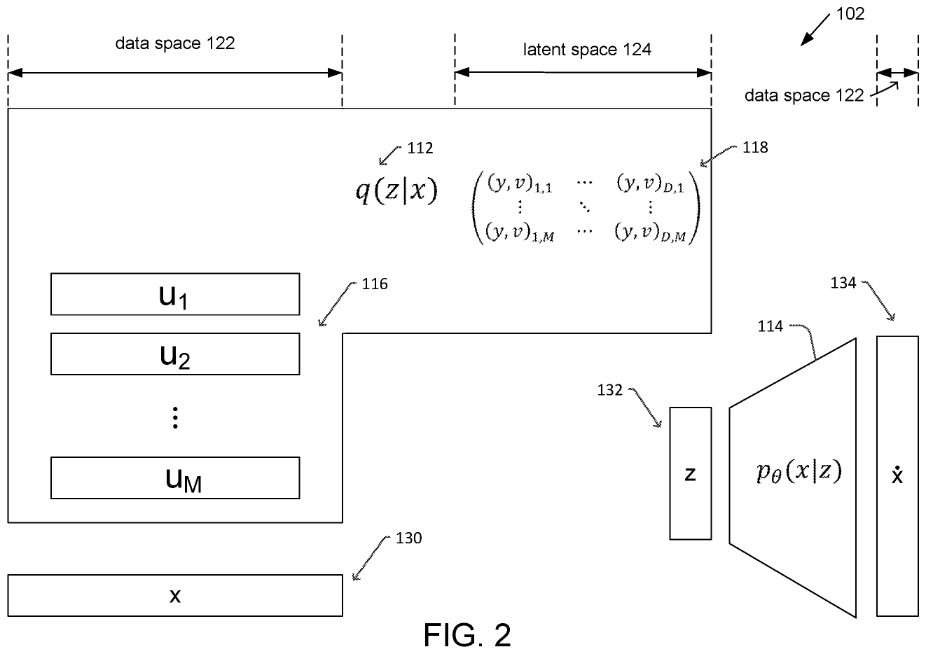

FIG. 2 is a diagram illustrating an example of the GP-VAE 102 of FIG. 1. The GP-VAE 102 includes, among other things, a Gaussian Process (GP) encoder 112 and a neural network decoder 114. In other words, the neural network encoder conventionally used in standard VAEs is replaced with the GP encoder 112. The GP encoder 112 learns to represent data points in latent space (z space) 124 based on their similarity, by using a kernel function. The GP encoder 112 produces principled uncertainty estimates. To achieve scalability, the GP encoder 112 is parametrized by using a number of inducing points 116. The inducing points 116 enable the learning of a mapping 118 from the data space 122 to the latent space 124. As shown in FIG. 2, the mapping 118 is a matrix having D columns and M rows, where D is the dimension of the latent space 124, and M is the number of inducing points 116. Details of the mapping 118 will be described in detail below. This sparse representation can be used to approximate the data likelihood during testing.

At a high level, the inducing points 116 and their corresponding values in the latent space 124 are learned. This allows the anomaly detection system 100 to employ a Gaussian process to infer the latent distribution 132 in the latent space 124 for data points 130 in the data space 122, which in turn can be decoded by the neural network decoder 114 into the data space 122. During testing, the anomaly detection system 100 can make use of the sparse representation learned by the GP-VAE 102 to detect OOD data points.

One exemplary way to implement the GP-VAE 102 is described in detail below. It should be noted that other ways to implement the GP-VAE 102 are within the scope of the disclosure.

Let {x₁, . . . , x_{N}} be a set of N data points 130, where xₙ∈R^{K}. The collection of the data points 130 can be represented as a staked matrix X∈R^{N×K}. The neural network decoder 114 is constructed with parameters θ that maximizes the data log-likelihood log log p_{θ} (X), as shown in equation (1) below.

$${p}_{θ} ( X ) = {\prod }_{n} {p}_{θ} ( {x}_{n} ) , {p}_{θ} ( x ) = \int {p}_{θ} ( x \vert 𝓏 ) p ( 𝓏 ) d 𝓏 , \qquad ( 1 )$$

where p_{θ} (x|z) is a conditional likelihood (i.e., “x given z”), and p(z) is the prior (probability). Each data point x is generated independently and is conditioned on a latent variable z∈R^{D}. Typically, D<<K. In other words, the dimension (D) of the latent space 124 is much smaller than the dimension (K) of the data space 122. When generating data points, a latent variable is first sampled using the prior p(z), and a data point is subsequently sampled using the neural network decoder 114.

Let {u₁, . . . , u_{M}} be a set of M inducing points 116, where uₘ∈R^{K}. For each m=1, . . . , M, let yₘ∈R^{D} and vₘ∈R_{>0}^{D} be a location vector and a noise vector, respectively. The location vector yₘ corresponds to the position of an observation in the latent space 124, whereas the noise vector vₘ corresponds to the uncertainty associated with the position of an observation in the latent space 124. These vectors are stacked into matrices Y, V∈R^{M×D}, and the dth column of the respective matrix is denoted by y^{d} and v^{d}. As shown in FIG. 2, the mapping 118 is a matrix having D columns and M rows, and each element of the matrix includes both the location component and the noise component. Let k(x,x′) be a positive-definite kernel. A positive-definite kernel is a generalization of a positive-definite function or a positive-definite matrix. Define by K=[k(uₘ, u_{m′})] the M×M matrix obtained by evaluating the kernel at each pair of inducing points. Given these, the dth dimension of the GP encoder 112 by equation (2) below,

μ_{d,ϕ}(x)=k^{T}[K+diag(v^{d})]⁻¹y^{d}, σ_{d,ϕ}²(x)=k(x, x)−k^{T}[K+diag(v^{d})]⁻¹k, (2)

where k=[k(x,U)].

The GP encoder 112, namely q(z|x), can be regarded as an auxiliary distribution that approximates the posterior distribution p(z|x). Commonly, the variational distribution is chosen to be a Gaussian with diagonal covariance where the mean and covariance matrix are functions of the input data points, as shown in equation (3) below,

q(z|x)= [symbol] {μ_{ϕ}(x), diag[σ_{ϕ}²(x)]} (3)

As shown in equation (3), the mean and covariance matrix are parameterized by Φ. As such, the functions μ_{Φ}(·) and σ_{Φ}(·) can be regarded as encoding the data points 130 into the latent distribution 132 in the latent space 124.

Putting equation (3) and equation (2) together, the GP encoder 112 is determined. The parameters of the GP encoder 112 are given by Φ={U, Y, V}, to which hyperparameters of the kernel functions are possibly added. The hyperparameters of the kernel functions control how different observations are correlated. As some examples, the hyperparameters of the kernel functions may be one or more of the following parameters: (1) effective distance such that the values at two locations are expected to be similar; (2) degree of smoothness of the values; (3) overall range of the values. Since the functions in equation (2) are differentiable with respect to Φ, they can be used as a drop-in replacement for neural network encoders in a standard VAE.

The GP-VAE 102 is trained by optimizing the evidence lower bound over parameters θ and Φ. Directly maximizing equation (1) is intractable. Instead, Jensen's inequality is used to derive the evidence lower bound, as shown in equation (4) below,

$$log {p}_{θ} ( X ) \geq {\sum }_{n} \{ {E}_{q ( 𝓏 \vert {x}_{n} )} [ log {p}_{θ} ( {x}_{n} \vert 𝓏 ) ] - KL [ q ( 𝓏 \vert {x}_{n} ) ‖ p ( 𝓏 ) ] \} , \qquad ( 4 )$$

On the other hand, the GP encoder 112 can be viewed as the output of an auxiliary Gaussian process recognition model \hat{z}(x) that maps from the data space 122 to the latent space 124. Assume, for simplicity, that the D dimensions of the multivariate GP's output are a priori identically and independently distributed, as shown in equation (5) below,

\hat{z}(x)˜ [symbol] 0, k(x, x′)I] (5)

Assume that for m=1, . . . , M, the Gaussian Process has value yₘ with Gaussian measurement noise diag(vₘ) at input uₘ. Then, equation (2) can be recognized as the predictive distribution of \hat{z}(x) at a new input data point x.

Referring back to FIG. 1, the database 106 includes a training dataset 108 and a testing dataset 110 in the example of FIG. 1. The training dataset 108 is used to train the GP-VAE 108. The testing dataset 110 is the actual data points that need anomaly detection. It should be noted that although only one training dataset 108 and one testing dataset 110 are shown in FIG. 1, the database 106 could include multiple training datasets 108 and multiple testing datasets 110 as needed.

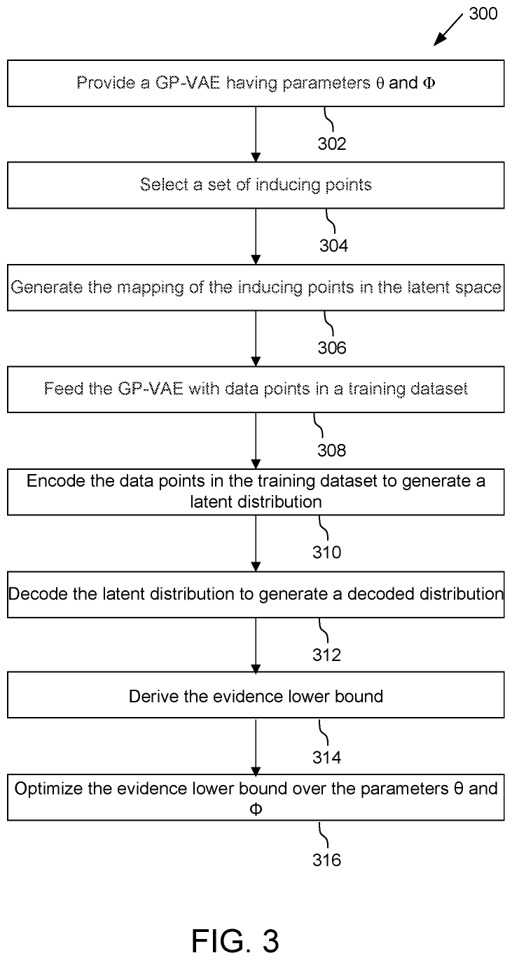

FIG. 3 is a flowchart diagram illustrating an example of a training flow 300. At step 302, the GP-VAE 102, which has parameters θ and Φ, is provided. As mentioned above, the GP-VAE 102 includes the GP encoder 112 and the neural network decoder 114. The parameters θ are parameters associated with the neural network decoder 114, whereas the parameters Φ are parameters associated with the GP encoder 112, as mentioned above.

At step 304, a set of inducing points 116, as shown in FIG. 2, is selected. At step 306, the mapping 118 of the inducing points 116 in the latent space 124 is generated. As mentioned above, the inducing points 116 enable the learning of the mapping 118 from the data space 122 to the latent space 124.

At step 308, data points 130 in a training dataset 108 are fed into the GP-VAE 102. At step 310, the data points 130 in the training dataset 108 are encoded by the GP encoder 112 to generate a latent distribution 132. The GP encoder 112 encodes the data points 130 in the training dataset 108 based on to what extent the data points 130 in the training dataset 108 are similar to the inducing points 116. In other words, if the data points 130 in the training dataset 108 are similar to the inducing points 116, the latent distribution 132 will be similar to the mapping 118 as well, and vice versa.

At step 312, the latent distribution 132 is decoded, using the neural network decoder 114, to generate a decoded distribution 134, as shown in FIG. 2. The decoded distribution 134 is again in the data space 122. As such, the GP-VAE 102 has knowledge of the inducing points 116, the mapping 118, the data points 130 of the training dataset 108, the latent distribution 132, and the decoded distribution 134, enabling the derivation of the evidence lower bound in the next step (i.e., step 314 below).

At step 314, the evidence lower bound is derived. In one example, the evidence lower bound is derived using Jensen's inequality, as shown in equation (4) above. At step 316, the evidence lower bound is optimized over the parameters θ and Φ. As such, the GP-VAE 102 has been trained using the data points 130 in the training dataset 108 once the optimal parameters θ and Φ are obtained.

Once the GP-VAE 102 has been trained, it can be used for anomaly detection. Given the testing dataset 110, i.e., {x₁*, . . . , x_{N}_{ₜ}*}, the anomaly detection system 100 can determine whether a data point in the testing dataset 110 is drawn from the same distribution as the training dataset 108 or is an OOD data point (i.e., anomaly).

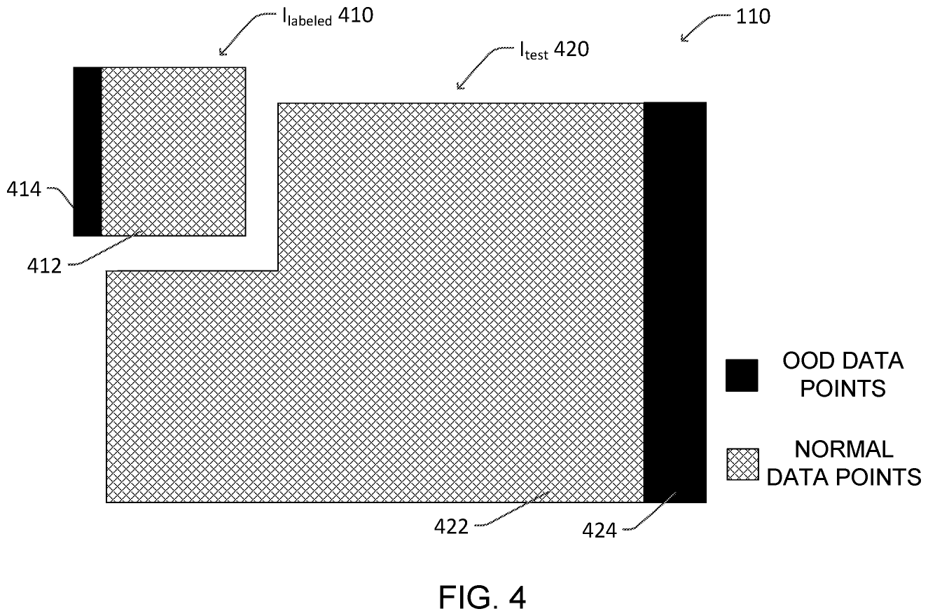

FIG. 4 is a diagram illustrating an example of the testing dataset 110. To determine a decision threshold, labeled testing data points 410, which are a small set in the testing dataset 110, may be used. As shown in the example of FIG. 4, the labeled testing data points 410 include both labeled normal data points 412 (denoted as Iₙₒᵣₘ) and labeled OOD data points 414 (denoted as I_{OOD}). The unlabeled testing data points 420 (denoted as Iₜₑₛₜ) also include unlabeled normal data points 422 and unlabeled OOD data points 424. The Anomaly detection system 100 is supposed to detect the unlabeled OOD data points 424 in the unlabeled testing data points.

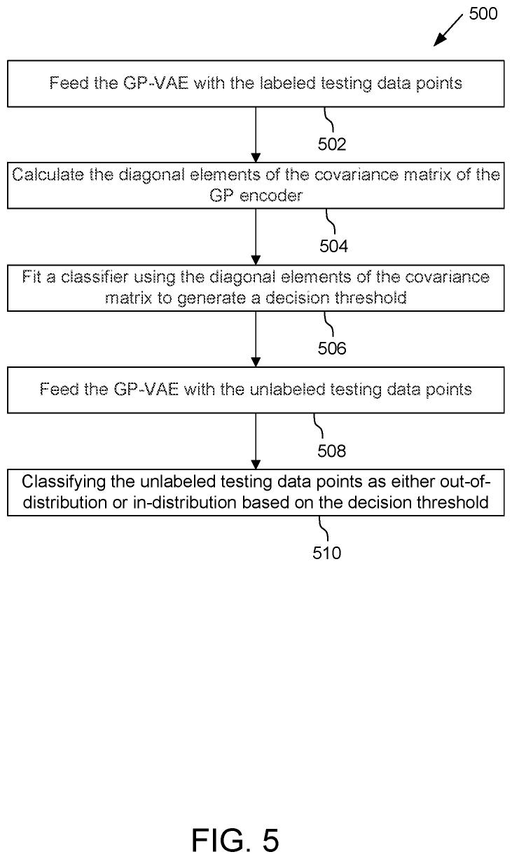

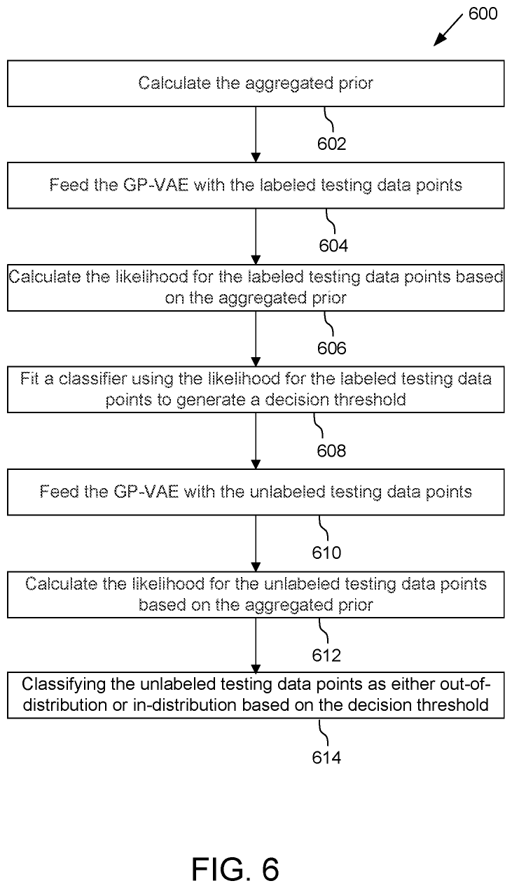

In general, the detection of the OOD data points 424 can be implemented in both the latent space 124 and the data space 122. The anomaly detection in the latent space, referred to as the latent variable-based OOD detection, is described in detail with reference to FIG. 5. The anomaly detection in the data space, referred to as the likelihood-based OOD detection, is described in detail with reference to FIG. 6.

As shown in FIG. 5, an example of a latent variable-based OOD detection process 500 includes steps 502, 504, 506, 508, and 510. At step 502, the GP-VAE 102, as shown in FIG. 2, is fed with the labeled testing data points 410, as shown in FIG. 4. The labeled testing data points 410 includes both the labeled normal data points 412 (denoted as Iₙₒᵣₘ) and the labeled OOD data points 414 (denoted as I_{OOD})

At step 504, the diagonal elements of the covariance matrix of the GP encoder 112 are calculated based on the labeled testing data points 410. In one implementation, the diagonal elements of the covariance matrix of the GP encoder 112 are

$${σ}_{n}^{2} ≐ {σ}_{ϕ}^{2} ( x )$$

and are calculated using the equation (2). These diagonal elements of the covariance matrix of the GP encoder 112 can be interpreted as a measure of how uncertain the GP-VAE is about the labeled testing data points.

At step 506, the classifier 184, as shown in FIG. 1, is fitted using the diagonal elements of the covariance matrix. In one implementation, the classifier 184 is a linear classifier. The decision threshold generator 182, as shown in FIG. 1, then generates a decision threshold that best distinguishes between the labeled normal data points 412 (denoted as Iₙₒᵣₘ) and the labeled OOD data points 414 (denoted as I_{OOD}).

At step 508, the GP-VAE 102 is fed with the unlabeled testing data points 420. The unlabeled data points 420 (denoted as Iₜₑₛₜ) also include unlabeled normal data points 422 and unlabeled OOD data points 424.

At step 510, the unlabeled testing data points 420 are classified as OOD data points and normal data points (i.e., ID data points) based on the decision threshold generated at step 506. In one implementation, the classifier 184 is used to implement the classification based on the decision threshold generated at step 506. Ideally, all of the unlabeled normal data points 422 should be classified as normal data points, whereas all of the unlabeled OOD data points 424 should be classified as OOD data points.

On the other hand, as shown in FIG. 6, an example of a likelihood-based OOD detection process 600 includes steps 602, 604, 606, 608, 610, 612, and 614. At step 602, an aggregated prior, instead of the prior p(z) in equation (1), is calculated, as shown in equation (6) below:

$$\hat{p} ( 𝓏 ) = \frac{1}{M} {\sum }_{m} q ( 𝓏 \vert {u}_{m} ) = \frac{1}{M} {\sum }_{m} 𝒩 ( {y}_{m} , diag ( {v}_{m} ) ) , \qquad ( 6 )$$

where uₘ are inducing points 116. The aggregated prior is very useful, especially in high dimensions. Because in high dimensions, the conventional sampling process can be infeasible and might include areas that are not covered by the approximate posterior q(z|x), which is sometimes referred to as the “holes problem.” Using the aggregated prior, the log-likelihood is calculated in accordance with equation (7) as shown below:

log p(xₙ*)=log ∫p_{θ}(xₙ*|z)\hat{p}(z)dx, (7)

All calculations of the log-likelihood in the likelihood-based OOD detection process 600 are based on the aggregated prior in accordance with equation (7).

At step 604, the GP-VAE 102, as shown in FIG. 2, is fed with the labeled testing data points 410, as shown in FIG. 4. The labeled testing data points 410 includes both the labeled normal data points 412 (denoted as Iₙₒᵣₘ) and the labeled OOD data points 414 (denoted as I_{OOD})

At step 606, the likelihood (values) for the labeled testing data points 410 are calculated based on the aggregated prior in accordance with equation (7).

At step 608, the classifier 184, as shown in FIG. 1, is fitted using the likelihood for the labeled testing data points 410. In one implementation, the classifier 184 is a linear classifier. The decision threshold generator 182, as shown in FIG. 1, then generates a decision threshold that best distinguishes between the labeled normal data points 412 (denoted as Iₙₒᵣₘ) and the labeled OOD data points 414 (denoted as I_{OOD})

At step 610, the GP-VAE 102 is fed with the unlabeled testing data points 420. The unlabeled data points 420 (denoted as Iₜₑₛₜ) also include unlabeled normal data points 422 and unlabeled OOD data points 424.

At step 612, the likelihood (values) for the unlabeled testing data points 420 are calculated based on the aggregated prior in accordance with equation (7).

At step 614, the unlabeled testing data points 420 are classified as OOD data points and normal data points (i.e., ID data points) based on the decision threshold generated at step 608. In one implementation, the classifier 184 is used to implement the classification based on the decision threshold generated at step 506. Ideally, all of the unlabeled normal data points 422 should be classified as normal data points, whereas all of the unlabeled OOD data points 424 should be classified as OOD data points.

It should be noted that the anomaly detection engine 104 in FIG. 1 is just one example. The anomaly detection engine 104 may include components other than the decision threshold generator 182 and the classifier 184 as needed.

In summary, real-world applications of machine learning systems require accurate detection of anomalous data points, and different components of the system need to be able to communicate uncertainty about their decisions. Due to the deficiencies of VAEs as mentioned above, the anomaly detection system 100 utilizing the GP-VAE 102 is introduced. The GP-VAE 102 includes the GP encoder 112, as shown in FIG. 2. The Gaussian process leads to better uncertainty estimates in the latent space 124, which in turn enables accurate detection of OOD data points in both the latent space 124 and the data space 122.

Since the GP encoder 112 is a drop-in replacement of the neural network encoder in conventional VAEs, the versatility of conventional VAEs is retained while gaining several advantages.

First, the combination of the Gaussian process, which is an instance of graphical models, and neural networks results in a powerful tool. It merges the advantages of graphical models, such as the ability to encode structured priors and accurate uncertainty estimates, with the advantages of neural networks, such as efficient representation learning and scalability. While the common neural network encoder can underestimate latent uncertainty, the Gaussian process expresses uncertainty over unknown input points reliably. Experiments have shown that GP-VAEs have additional advantages over conventional VAEs, such as robustness to noise and the freedom to choose the kernel function.

Second, since the aggregated prior, instead of the reconstruction error as in conventional VAEs, is used, more reliable estimates for the testing data points are generated and overconfident unreliable estimates are avoided. The “holes problem” in high dimensions are solved as well.

Third, the GP-VAE 102 makes fewer assumptions about the generative process of the data and is therefore more flexible.

Fourth, the GP-VAE 102 relies on inducing points 116 in the data space 122 and therefore does not require additional auxiliary distributions.

Embodiments of the present disclosure may be conveniently implemented using one or more conventional general purpose or specialized digital computer, computing device, machine, or microprocessor, including one or more processors, memory and/or computer-readable storage media programmed according to the teachings of the present disclosure. Appropriate software coding can readily be prepared by skilled programmers based on the teachings of the present disclosure, as will be apparent to those skilled in the software art.

In some embodiments, the present disclosure includes a computer program product which is a non-transitory storage medium or computer-readable medium (media) having instructions stored thereon/in which can be used to program a computer to perform any of the processes of the present disclosure. Examples of the storage medium can include, but is not limited to, any type of disk including floppy disks, optical discs, DVD, CD-ROMs, microdrive, and magneto-optical disks, ROMs, RAMS, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present disclosure has been provided for the purposes of illustration and description. It is not intended to be exhaustive or limited to the precise forms disclosed. Many modifications and variations will be apparent to the practitioner skilled in the art.

The various embodiments described above are provided by way of illustration only and should not be construed to limit the claims attached hereto. Those skilled in the art will readily recognize various modifications and changes that may be made without following the example embodiments and applications illustrated and described herein.

What is claimed is:

1. A method comprising:
providing a Gaussian process variational autoencoder (GP-VAE) including a Gaussian process (GP) encoder and a neural network decoder;
selecting a plurality of inducing points in a data space;
generating a mapping of the plurality of inducing points in a latent space; and
training the GP-VAE using a training dataset.

2. The method of claim 1, wherein the training further comprises:
feeding the GP-VAE with data points in the training dataset;
encoding the data points in the training dataset to generate a latent distribution in the latent space;
decoding the latent distribution to generate a decoded distribution;
deriving an evidence lower bound; and
optimizing the evidence lower bound over parameters of the GP-VAE.

3. The method of claim 2, wherein the evidence lower bound is derived using a Jensen's inequality.

4. The method of claim 2, wherein the parameters of the GP-VAE comprise parameters associated with the neural network decoder and parameters associated with the GP encoder.

5. The method of claim 1, wherein the mapping of the plurality of inducing points is a matrix having M columns and D rows, each of the M columns corresponding to one of the plurality of inducing points, and each of the D rows corresponding to one of dimensions of the latent space.

6. The method of claim 1 further comprising:
feeding the GP-VAE with labeled testing data points;
calculating diagonal elements of a covariance matrix of the GP encoder;
fitting a classifier using diagonal elements of the covariance matrix to generate a decision threshold;
feeding the GP-VAE with unlabeled testing data points; and
classifying the unlabeled testing data points as either out-of-distribution or in-distribution based on the decision threshold.

7. The method of claim 1 further comprising:
calculating an aggregated prior;
feeding the GP-VAE with labeled testing data points;
calculating likelihood values for the labeled testing data points based on the aggregated prior;
fitting a classifier using the likelihood values for the labeled testing data points to generate a decision threshold;
feeding the GP-VAE with unlabeled testing data points; and
classifying the unlabeled testing data points as either out-of-distribution or in-distribution based on the decision threshold.

8. The method of claim 7, wherein the aggregated prior is calculated based on the plurality of inducing points.

9. At least one non-transitory computer readable storage device storing data instructions that, when executed by at least one server including at least one processor, cause the at least one server to:
provide a Gaussian process variational autoencoder (GP-VAE) including a Gaussian process (GP) encoder and a neural network decoder;
select a plurality of inducing points in a data space;
generate a mapping of the plurality of inducing points in a latent space; and
train the GP-VAE using a training dataset.

10. The at least one non-transitory computer readable storage device of claim 9, wherein the data instructions, when executed by the at least one server including the at least one processor, cause the at least one server to:
feed the GP-VAE with data points in the training dataset;
encode the data points in the training dataset to generate a latent distribution in the latent space;
decode the latent distribution to generate a decoded distribution;
derive an evidence lower bound; and
optimize the evidence lower bound over parameters of the GP-VAE.

11. The at least one non-transitory computer readable storage device of claim 10, wherein the evidence lower bound is derived using a Jensen's inequality.

12. The at least one non-transitory computer readable storage device of claim 10, wherein the parameters of the GP-VAE comprise parameters associated with the neural network decoder and parameters associated with the GP encoder.

13. The at least one non-transitory computer readable storage device of claim 9, wherein the mapping of the plurality of inducing points is a matrix having M columns and D rows, each of the M columns corresponding to one of the plurality of inducing points, and each of the D rows corresponding to one of dimensions of the latent space.

14. The at least one non-transitory computer readable storage device of claim 9, wherein the data instructions, when executed by the at least one server including the at least one processor, cause the at least one server to:
feed the GP-VAE with labeled testing data points;
calculate diagonal elements of a covariance matrix of the GP encoder;
fit a classifier using the diagonal elements of the covariance matrix to generate a decision threshold;
feed the GP-VAE with unlabeled testing data points; and
classify the unlabeled testing data points as either out-of-distribution or in-distribution based on the decision threshold.

15. The at least one non-transitory computer readable storage device of claim 9, wherein the data instructions, when executed by the at least one server including the at least one processor, cause the at least one server to:
calculate an aggregated prior;
feed the GP-VAE with labeled testing data points;
calculate likelihood values for the labeled testing data points based on the aggregated prior;
fit a classifier using the likelihood values for the labeled testing data points to generate a decision threshold;
feed the GP-VAE with unlabeled testing data points; and
classify the unlabeled testing data points as either out-of-distribution or in-distribution based on the decision threshold.

16. The at least one non-transitory computer readable storage device of claim 15, wherein the aggregated prior is calculated based on the plurality of inducing points.
